(19) United States
(12) Patent Application Publication
(10) Pub. No.: US 2006/0226312 A1
(43) Pub. Date: Oct. 12, 2006

(54) Device for connecting two components at a distance apart from one another

(76) Inventor: Frank Masuch, Duesseldorf (DE)

Correspondence Address: ST. ONGE STEWARD JOHNSTON & REENS, LLC, 986 BEDFORD STREET, STAMFORD, CT, 06905-5619, US

(21) Appl. No.: 11/416,598

(22) Filed: May 3, 2006

Related U.S. Application Data
(63) Continuation of application No. PCT/EP04/52935, filed on Nov. 12, 2004.

(30) Foreign Application Priority Data
Nov. 15, 2003 (DE) 103 54 062.8

(51) Int. Cl. F16M 11/16

(52) U.S. Cl. 248/188

(57) ABSTRACT

The invention relates to a device for connecting two structural components at a distance to each other by means of a connecting bolt, a spacer leg lying between the two structural components, and a fastening leg connected therewith in a junction point and comprising the mating thread for the connecting bolt. The invention is characterized by composite elements associated with the leg ends and located opposite the junction point for fastening the two legs on each other, thereby forming a hinge, especially a film hinge.

### CROSS-REFERENCE TO RELATED APPLICATIONS

This application is a continuation of International Patent Application No. PCT/EP2004/052935 filed on Nov. 12, 2004, which designates the United States and claims priority of German Patent Application No.10354062.8 filed on Nov. 15, 2003

### FIELD OF THE INVENTION

The invention relates to a device for connecting two components at a distance apart from one another by means of a connecting screw, having a spacing leg which is located between the two components, and having a fastening leg which is connected to the spacing leg at a connecting location and has the mating thread for the connecting screw.

### BACKGROUND OF THE INVENTION

A device of the type in question is known from FR 2 492 015, in which case the spacing leg, which is connected to the fastening leg via a connecting crosspiece, forming, on its broad surface which is directed towards the fastening leg, a conical collar which surrounds the hole for the connecting screw. This produces a latching connection in relation to a component which, accordingly, extends between the two legs. As long as the connecting screw has not been screwed in, it is possible, once the latching force has been overcome, for the legs connected via the connecting location to be disengaged from the one component.

### SUMMARY OF THE INVENTION

It is an object of the invention to develop a device of the type in question to the effect that the legs are reliably secured on the one component even when the connecting screw is not brought into engagement.

This object is achieved first and foremost in the case of a device having the features of Claim 1, this being based on the fact that interlocking elements which are associated with the leg ends located opposite the connecting location are intended for securing the two legs on one another.

The subject matters of the rest of the Claims are explained hereinbelow in relation to the subject matter of Claim 1, but may also be important in their independent formulation.

Such a configuration provides a device of the generic type with increased use value. The interlocking elements located opposite the connecting location lead to a configuration of the legs which is closed all the way round, so that, when secured on a component, it is ensured that the spacing leg and fastening leg are captive, even if the connecting screw has still not been fitted. This leads to installation-related advantages. It is also the case that the interlocking elements retain the legs in the intended position in relation to one another. The interlocking elements make it possible to configure the connecting location between the legs in the form of a hinge. With the hinge pivoted open, it is then possible preferably for the fastening leg to be straightforwardly placed in position in relation to the component. Once this has taken place, the spacing leg can be moved into the prescribed position, with simultaneous inter-engagement of the interlocking elements. The hinge is preferably configured as a film hinge. Accordingly, there is no need for any additional components for the purpose of forming the hinge. In detail, there is provided according to the invention a configuration such that the interlocking elements form a crosspiece which is associated, in particular, with the fastening leg, which has the mating thread. For placing the crosspiece in position on the one component, all that is required is for this crosspiece to be inserted, for example, through an opening of the component. That portion of the crosspiece which projects beyond this opening is then used in order for it to be possible to bring the interlocking elements into engagement with one another. For this purpose, it is advantageous if the interlocking elements form a hook plate associated, in particular, with the spacing leg. When the interlocking elements are brought into engagement with one another, this hook plate is brought into a hook-engagement position in relation to the crosspiece. In detail, the procedure here is such that the crosspiece forms a fork mouth for accommodating the hook plate, of which the hook side portions engage beneath the fork tines. Following the hooked engagement of these portions beneath the fork tines, the legs are secured against spreading apart from one another, so that they remain parallel to the corresponding region of the one component. In order that this hooked engagement cannot be released unintentionally, the fork tines form latching niches for the hook side portions. It is only once the latching force has been overcome that the hook plate can be disengaged from the fork tines. However, a plug-in connection then still remains between the crosspiece of the fastening leg and the component. In particular, it is recommended for the fastening leg and the spacing leg with the film hinge connecting them to be produced from plastics material by injection molding. This makes advantageous production possible. In order, nevertheless, for it to be possible to absorb a high tensioning force, exerted by the connecting screw, the mating thread is formed by an, in particular, metallic insert part which fits in a plastics part which forms the legs. Finally, the provision of a spacer part which is associated with the spacing leg and comprises a retaining part and a supporting part which is variable in relation to the latter is also regarded as an advantageous feature of the invention. Even if there is a distance between the spacer part and the component facing it, it is possible to bridge the distance using the spacer part when the connecting screw is inserted. This means that, when the connecting screw is tightened, the component which comes into contact with the spacer part, and may be a metal sheet, maintains its intended alignment and is not bent. The supporting part can be supported in relation to the retaining part for example by a thread. It is possible here to select a thread which runs in the opposite direction to the mating thread, so that, when the connecting screw is screwed in, the supporting part is inevitably unscrewed into the supporting position. A tight fit of the connecting screw in the supporting part is recommended for this purpose. Once the supporting part is butting against the component associated with it, there is no further displacement of the supporting part, so that the connecting screw engages exclusively, as intended, with the mating thread.

### BRIEF DESCRIPTION OF THE DRAWINGS

An exemplary embodiment of the invention is explained hereinbelow with reference to the drawings, in which:

FIG. 1 shows, in longitudinal section, a device associated with the one component, prior to connection,

FIG. 2 shows the view in arrow direction II in FIG. 1 depicting the interlocking engagement between the hook plate and crosspiece,

FIG. 3 shows a plan view of the device in arrow direction III in FIG. 1,

FIG. 4 shows the follow-up illustration to FIG. 1, the connecting screw having been plugged into the supporting part with a friction fit,

FIG. 5 shows the follow-up illustration to FIG. 4, but, in contrast to the latter, with the supporting part assuming the supporting position and the connecting screw brought into the tensioning position,

FIG. 6 shows a perspective illustration specifically of the device associated with the one component, that is to say with the interlocking elements brought into engagement,

FIG. 7 shows a side view of the legs connected by the film hinge in the state in which they are supplied, and

FIG. 8 shows, in a vastly enlarged illustration, the section along line VIII-VIII in FIG. 2.

### DETAILED DESCRIPTION OF THE INVENTION

The device, which is designated as a whole by the reference numeral 1, serves for connecting two components 2 and 3 at a distance apart from one another by means of a connecting screw 4. The component 2 is a customized component which, in the case of the exemplary embodiment, is of substantially angular configuration with two angled legs 5 and 6 which are stabilized by junction walls 7. The material selected for the component 2 is plastics material. This allows the component 2 to be produced as a plastics injection molding.

The other component 3 is one with a plate-like configuration. It has a plug-through opening 8 for the connecting screw 4. In alignment with the plug-through opening 8, the angled leg 5 of the other component 2 forms an opening 9. This alignment is present if the device 1 has maintained its positioning in relation to the component 2.

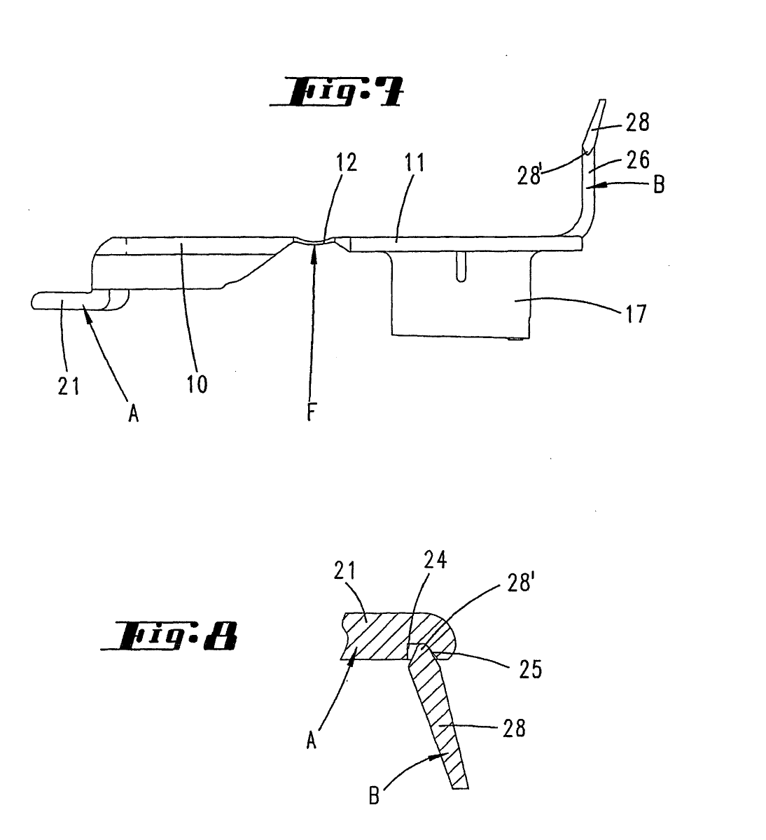

The device 1 contains a fastening leg 10 and a spacing leg 11, which are connected to one another via a connecting location 12. The connection location here is a film hinge F. Both the fastening leg 10 and the spacing leg 11, which is connected to the fastening leg via the film hinge F, consist of plastics material and are produced by plastics injection molding. After the injection molding, the two legs are in the supply state, which is depicted in FIG. 7 and in which the fastening leg 10 and the spacing leg 11 are located in a single plane in relation to one another. A metallic insert part 13 is incorporated in the fastening leg 10 during the injection molding. This insert part contains a mating thread 14 for the connecting screw 4. The insert part 13 is a flanged nut which is seated in a non-rotatable manner in the fastening leg 10. The mating thread 14 is aligned with the opening 9 and the plug-through opening 8.

A nut-like retaining part 15 is seated in the spacing leg 11 such that it cannot be rotated or displaced axially. The retaining part 15 is provided with an internal thread 16, which runs in the opposite direction to the mating thread 14 of the insert part 13. For the purpose of accommodating the retaining part 15, the spacing leg 11 forms a collar 17 which extends from the spacing leg and projects in the axial direction beyond the retaining part 15 to a certain extent. Interacting with the internal thread 16 is an external thread 18 of a supporting part 19, which is screwed into the retaining part 15. These two parts, the retaining part 15 and the supporting part 19, form a variable spacer part which is associated with the spacing leg 11.

The supporting part 19 forms a compensating element and is of sleeve-like configuration. A bushing-like spring element 20 is located in the sleeve interior in a state in which it cannot be rotated or displaced axially in the insertion direction of the connecting screw 4. Extending from the spring element 20 are radially inwardly directed tongues 20′ which, when the connecting screw 4 is inserted, assume a clamping position in relation to the external thread of the connecting screw. On the far side of the spring element 20, the supporting part 19 carries a stop ring 19′. The latter interacts, in a manner which will not be described in any more detail, with stop and latching elements on the end side of the collar. The stop element serves to make it not possible, in the starting position, for the supporting part 19 to be screwed any further in the inward direction. For a rotation in the other direction, that is to say in the unscrewing direction, it is necessary to overcome the action of a catch. The latter also serves, in known manner, as a securing means for transportation, so that unintentional unscrewing of the supporting part 19 cannot take place.

A radially outwardly projecting crosspiece 21 is integrally formed on the fastening leg 10 diametrically opposite the film hinge F. With the device 1 mounted, this crosspiece runs parallel to the angled leg 5. Specifically, the crosspiece 21 has a fork mouth 22 with fork tines 23 adjacent to the latter. On their underside, the fork tines 23 form latching niches 24, with which run-on slopes 25 are associated. The crosspiece 21 thus constitutes one interlocking element A. The other interlocking element B is associated with the spacing leg 11. For this purpose, a hook plate 26 extends from this spacing leg, diametrically opposite the film hinge F. This hook plate is located on that side of the spacing leg 11 which is opposite the collar 17. The hook plate 26 runs approximately at right angles to the spacing element 11 and, in the use state of the device, parallel to the longitudinal direction of the connecting screw 4. The hook plate 26 has a hook 27 at its end. This hook has hook side portions 28 projecting laterally beyond the hook plate 26. In cross section, these hook side portions have roof-like ends 28′ which enter into the latching niches 24, see FIG. 8. The width of the hook plate 26 corresponds to the extent of the fork mouth 22.

In order for it to be possible for the legs 10, 11 to be placed in a captive position in relation to the component 2, the angled leg 6 has a plug-in opening 29 of approximately rectangular profile, which opening is larger than the cross section of the crosspiece 21.

The device 1 is placed in position in such a manner that, in the first instance, the crosspiece 21 in its supply state, as can be gathered from FIG. 7, is introduced into the plug-in opening 29. This means that the fastening leg 10 is then located beneath the angled leg 5. The spacing leg 11 is subsequently swung around the film hinge F, in which case, in the end phase of the swing-action displacement, the hook plate 26 passes into the fork mouth 22 and the hook side portions 28 engage beneath the fork tines 23. The hook ends 28′ here pass into the latching niches 24, so that the legs 10, 11 accommodate the angled leg 5 between them in a parallel arrangement and are secured in this position by the interlocking elements A, B.

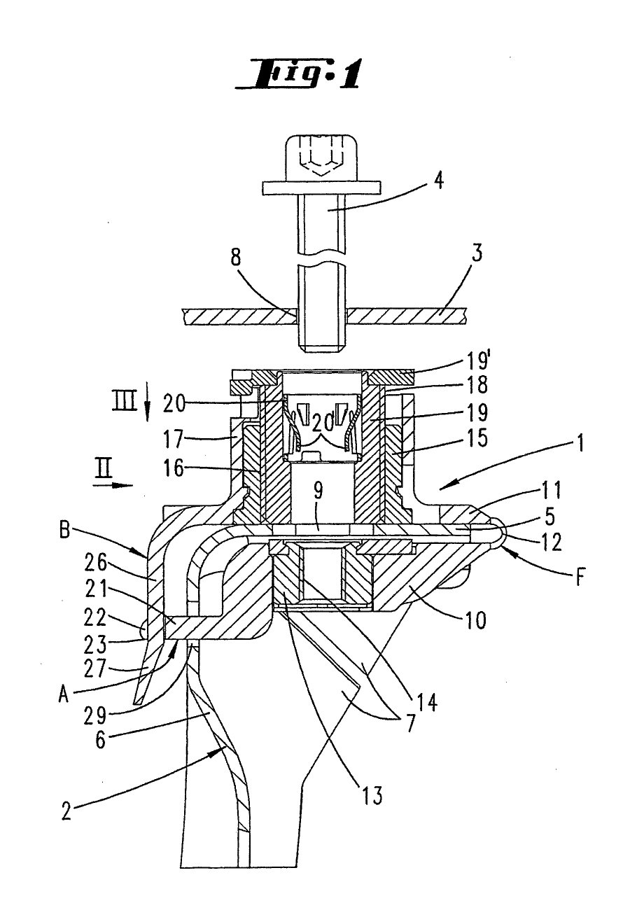

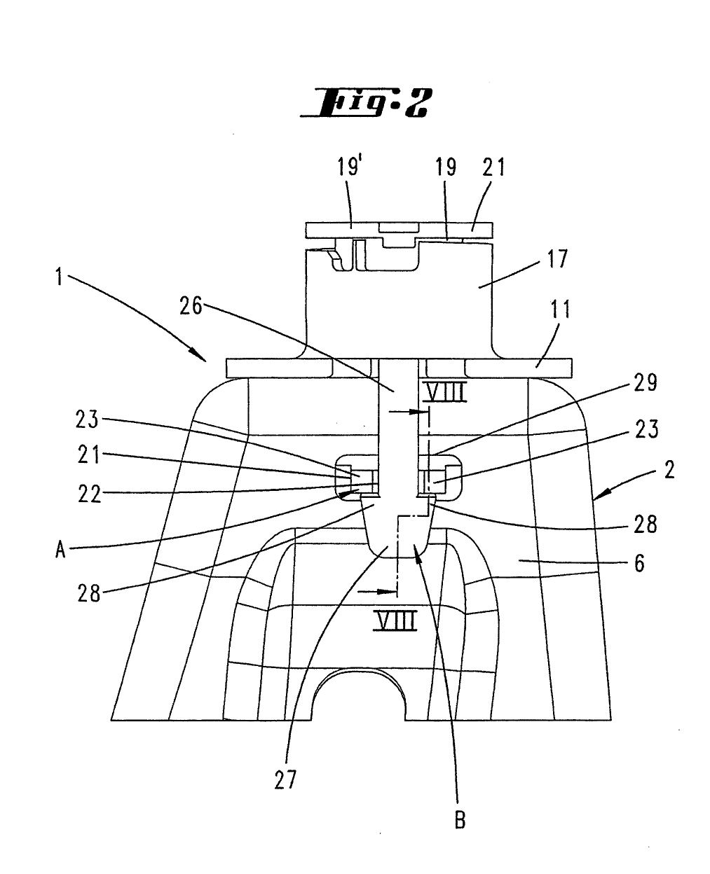

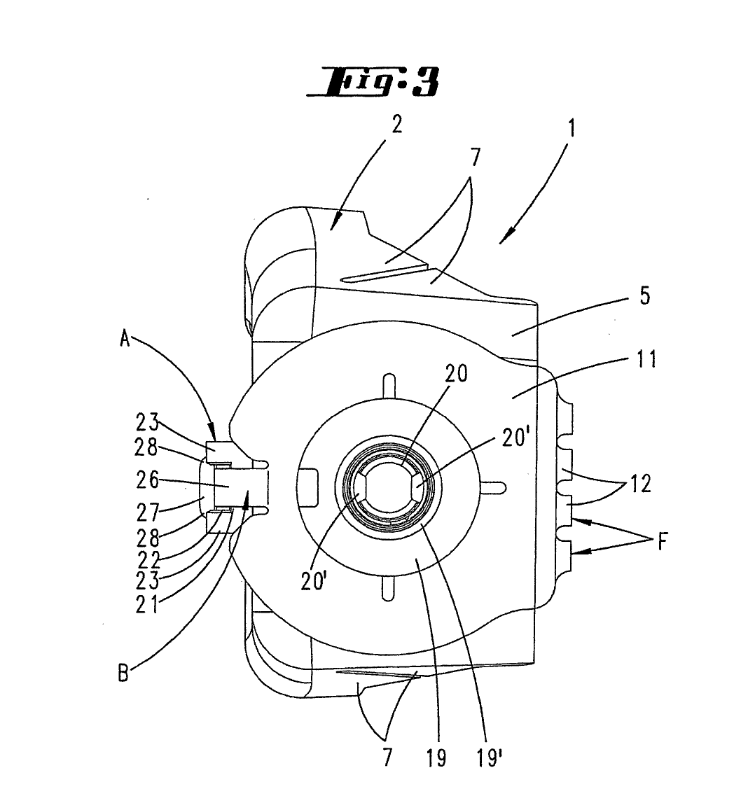

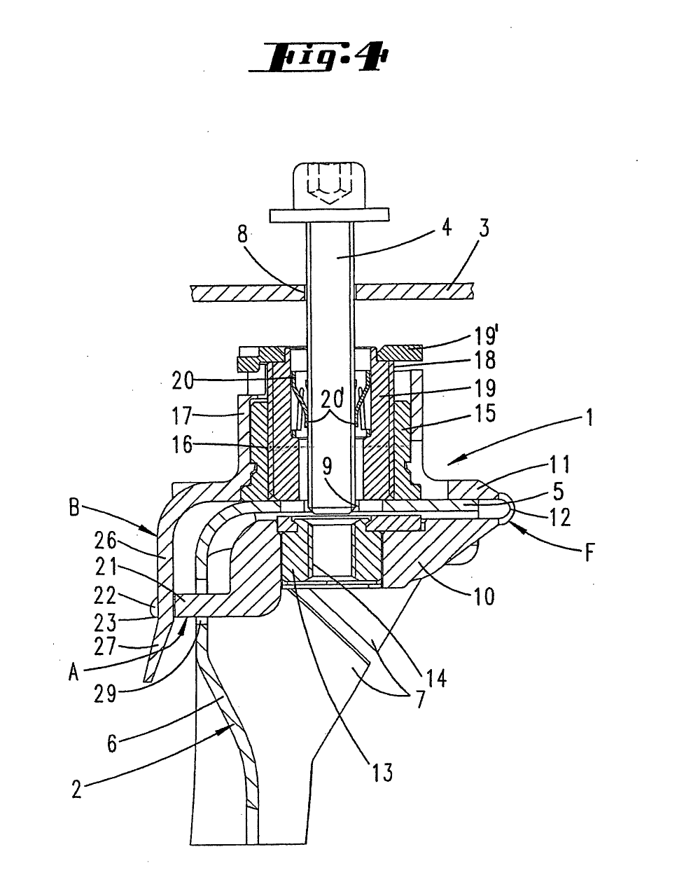

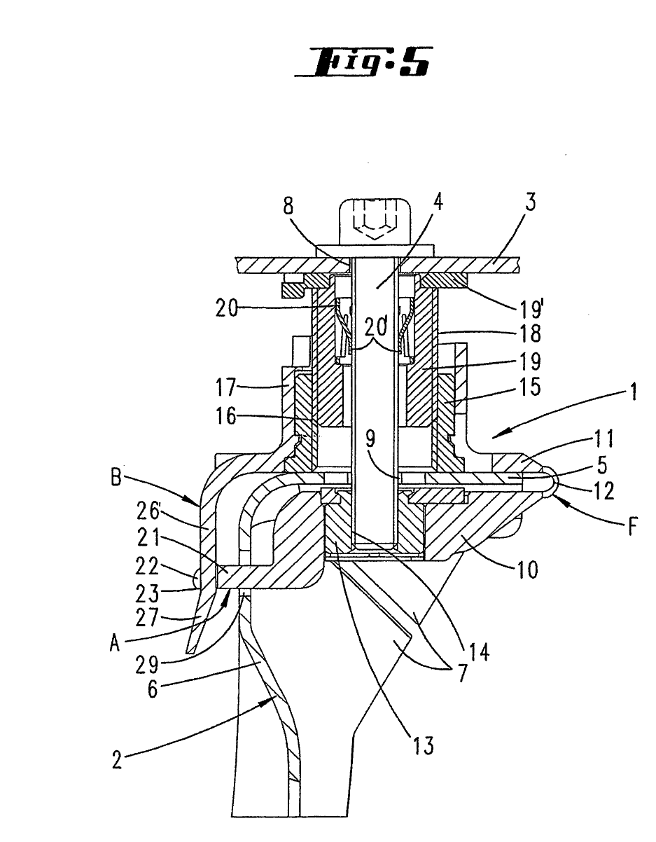

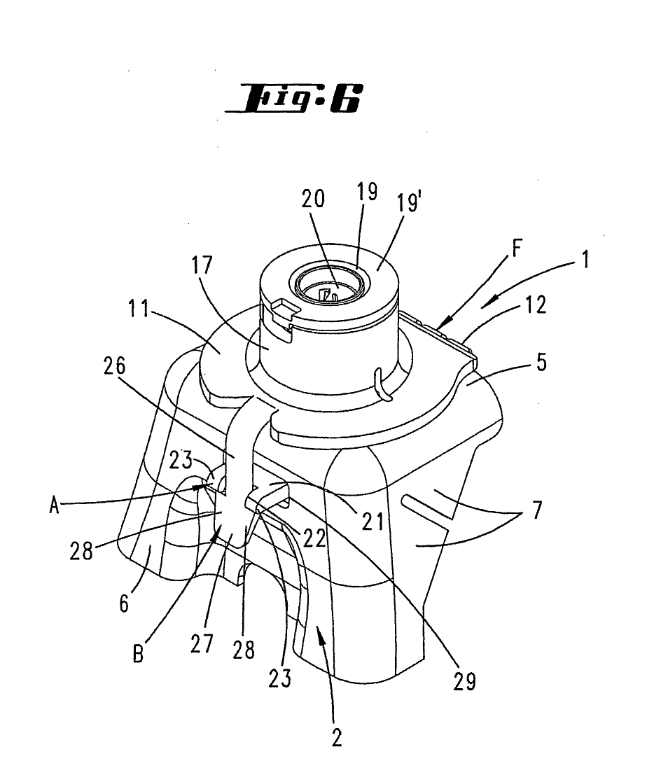

It is then possible for the connecting screw 4 to be plugged in, as is illustrated in FIGS. 1 and 4. The shank of the connecting screw 4 here assumes a clamping position in relation to the tongues 20′ of the spring element 20. If the connecting screw 4 is then screwed in the tightening direction, this is accompanied by the supporting part 19 being unscrewed, in abutment against the component 3. The connecting screw 4 can then engage in the mating thread 14 and be screwed further in the tensioning direction. The clamping action in relation to the spring tongues 20′ is overcome there, so that just sliding friction remains between the same. The state according to FIG. 5 is then brought about by way of bracing. It can be seen in FIG. 5 that the two components 2 and 3 are braced at the intended distance apart from one another without the component 3 being bent in the process.

All features disclosed are (in themselves) pertinent to the invention. The disclosure content of the associated/attached priority documents (copy of the prior application) is hereby also included in full in the disclosure of the application, also for the purpose of incorporating features of these documents in claims of the present application.

1. Device for connecting two components at a distance apart from one another by means of a connecting screw, having a spacing leg which is located between the two components, and having a fastening leg which is connected to the spacing leg at a connecting location and has the mating thread for the connecting screw, characterized by interlocking elements which are associated with the leg ends located opposite the connecting location and are intended for securing the two legs on one another and for securing the device in captive fashion on one of the components.

2. Device according to claim 1, characterized in that the connecting location forms a hinge, in particular film hinge.

3. Device according to claim 1, characterized in that the interlocking elements form a crosspiece which is associated, in particular, with the fastening leg, which has the mating thread.

4. Device according to claim 1, characterized in that the interlocking elements form a hook plate associated, in particular, with the spacing leg.

5. Device according to claim 1, characterized in that the crosspiece forms a fork mouth for accommodating the hook plate, of which the hook side portions engage beneath the fork tines.

6. Device according to claim 5, characterized in that the fork tines form latching niches for the hook side portions.

7. Device according to claim 3, characterized in that the mating thread is formed by an, in particular, metallic insert part which fits in a plastics part which forms the legs.

8. Device according to claim 1, characterized by a spacer part which is associated with the spacing leg and comprises a retaining part and a supporting part which is variable in relation to the latter.
